(19) United States
(12) Patent Application Publication
(10) Pub. No.: US 2016/0292719 A1
(43) Pub. Date: Oct. 6, 2016

(54) DEAL DISTRIBUTION PLATFORM

(71) Applicant: Thrive Commerce, LLC, Havertown, PA (US)

(72) Inventors: Manu Gambhir, Philadelphia, PA (US); Scott David Bohrer, Havertown, PA (US); Seth Jared Besmertnik, New York, NY (US)

(21) Appl. No.: 15/092,295

(22) Filed: Apr. 6, 2016

Related U.S. Application Data
(60) Provisional application No. 62/143,541, filed on Apr. 6, 2015.

(51) Int. Cl. G06Q 30/02

(52) U.S. Cl. CPC G06Q 30/0246; G06Q 30/0242

(57) ABSTRACT

A method and system for a deal distribution platform are provided. Retrieving, by a content generator, search engine optimized (SEO) information relating to a given client, from a configuration database is provided. The content generator may combine the retrieved information with one or more page templates and create one or more savings center pages. The one or more savings center pages may be published via a web server and made viewable by one or more users or shoppers.

### FIELD OF INVENTION

This invention relates to a client server system and more particularly a deal distribution platform.

### BACKGROUND

Online merchants often use sales, coupons and other types of deals (ex: rebates, buy-one-get-one-free, etc.) as a marketing tactic to attract and retain shoppers. Currently, merchants use a variety of tools to advertise these deals to their prospective customers which are cumbersome to implement, track, and can be costly. It would be desirable to have a method and apparatus to implement, track, and advertise deals to prospective customers in a streamlined and cost-effective manner.

In one embodiment, our method and apparatus may provide a deal distribution platform where merchants enter their deals and choose which channels to publish those deals (via search engines, affiliate marketers, blogs, online advertising, offline advertising, emails, social media, etc.). Merchants may also be able to obtain analytics on their deals.

Another embodiment may involve publishing content accessible to search engines. Many consumers search via Google and Bing for coupons and sales. In the search engine channel, the platform may surface the deals of merchants using the platform usually at a very high ranking due to our search engine optimized (SEO) content and platform integration approach. The benefit for merchants is that their web pages containing their deals may surface with very high rankings (often the top 3) in search engines. This may allow merchants to greatly reduce paying fees to third-party companies who currently capture this search traffic and then resell it to the merchants—usually on a commission basis. Furthermore, merchants may be able to obtain analytics on shoppers searching for and using their deals and they may be able to control the user experience of shoppers arriving at their landing pages featuring their deals.

### SUMMARY

Methods and systems for a deal distribution platform are provided. Retrieving, by a content generator, search engine optimized (SEO) information relating to a given client, from a configuration database is provided. The content generator may combine the retrieved information with one or more page templates and create one or more savings center pages. The one or more savings center pages may be published via a web server and made viewable by one or more users or shoppers.

A request for deal content may be received from a first computing device and deal content may be generated by a content generator subsystem and sent in response to the request. Systems and methods for publishing promotions and/or offers across various online and offline distribution channels for the purpose of offering promotions and other offers to shoppers, and obtaining data showing the financial performance and shopper interest in the offers and promotions are further provided.

The distribution channels include, but are not limited to search engines such as Google and Bing, third-party websites and apps including blogs and portals, paid online and offline advertising, location-aware devices such as smartphones, and offline media such as newspapers, circulars, and free-standing inserts.

### BRIEF DESCRIPTION OF THE DRAWINGS

FIG. 1 is a diagram of an example savings center platform;

FIG. 2 is an example network diagram illustrating flow between the internet, a merchant web server, and a host web server; and

FIG. 3 shows an exemplary connection between a web system, computing device, and the internet.

### DETAILED DESCRIPTION OF THE PREFERRED EMBODIMENTS

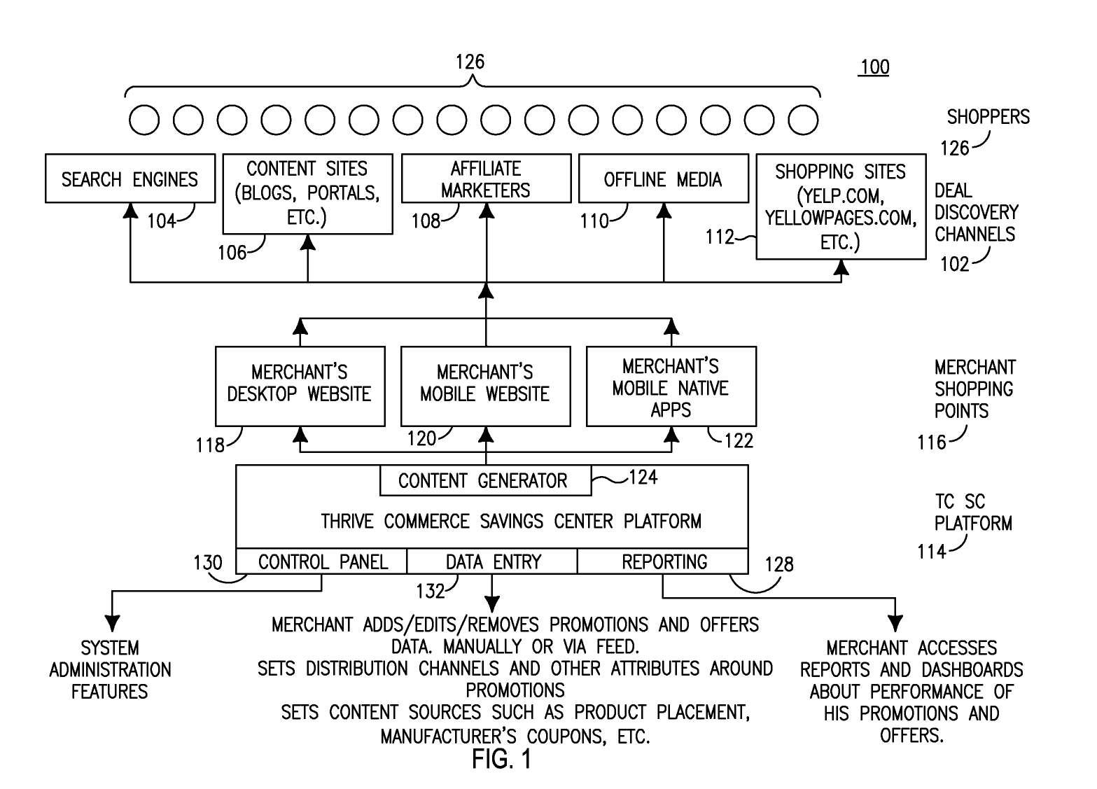

FIG. 1 shows an example savings center platform whereby a number of subsystems may be provided.

A data entry subsystem is provided whereby information may be entered into the platform—either manually or automatically. Information may include content related to promotions and/or offers on the merchant's products and services as well as third-party syndicated content including third-party promotions, advertisements and reviews.

Via a reporting subsystem, users may be able to access reports, dashboards and be able to perform ad-hoc queries on the performance of various campaigns, promotions and offers.

A control panel subsystem may be provided in order to permit configuration for each merchant including settings such as look and feel, SEO parameters, user access, roles, audit logging and other features.

A content generator subsystem may be provided to generate the web pages and web content that may be published on the merchant's website(s) and applications (apps) and contain the offers, deals and other content entered via the data entry subsystem and is designated to be made available to shoppers by the merchant.

Merchant shopping points may be included and perform as touchpoints whereby an online shopper may interact with a merchant and may include a merchant's website(s) on desktop, mobile and other devices as well as merchant's apps—desktop or native.

FIG. 1 shows exemplary deal discovery channels. The channels may be online and interactive touchpoints where shoppers can find deals. Search engines 104 are one example as many shoppers search for terms such as merchant name+coupon but they are not the only example as shoppers may look for deals on sites such as Yelp, Yellowpages.com, Zagats, Facebook, Twitter and many others. Other exemplary deal distribution channels include content sites such as blogs or portals 106, membership organization websites, or the like, affiliate marketers 108, offline media 110, and shopping sites 112, among others.

The savings center 114 may comprise a database, the design of which is specified hereinafter, and surrounding applications, for example, subsystems. When a new merchant signs up to use the savings center, the control panel subsystem 130 may provide the necessary tools to configure the various parameters for this client. All of these parameters may be stored in the database.

A merchant may provide an area of their website, including a desktop website 118, a mobile website 120, or native applications 122, into which web pages related to the savings center may be published. These merchant sites may be referred to as merchant shopping points 116. The mechanics of how this may be accomplished are disclosed hereinafter. These web pages may be SEO optimized and contain the actual deals and offers. These pages may be generated by the content generator application 124 which may obtain all of the deals from the database and then, using the parameters entered via the control panel, create a directory of web pages which may be served to or hosted on the specified area of the merchant's website or app. The actual deals and offers contained in these webpages may be loaded into the database using the data entry subsystem 132 as indicated above.

Shoppers 126 may discover the deal web pages hosted on the merchant's site either via links on the merchant site 118-122, links from third parties, via search engines 104, or through other means. All of the activity performed by users when visiting these webpages may be logged in a database.

Merchants may run reports to analyze the performance of their deals and offers via the reporting subsystem 128 which will access the activity logs of the users who have visited the web pages in the merchant's savings center.

Web Pages may be published into a merchant's site in a variety of ways—depending on the preferences of the merchant's Information Technology (IT) team and the optimal choice from an SEO perspective. Disclosed below are exemplary methods.

A merchant may create a subdirectory on their website to hold the savings center pages and then the pages, which are pre-generated, are uploaded into this subdirectory. For instance, the merchant may create “www.merchantsite.com/savingscenter” and then upload the savings center pages into this subdirectory. This upload can be done manually or automatically—depending on the preferences of the merchant. Each time the savings center pages are updated the modified pages are re-uploaded to the relevant directory.

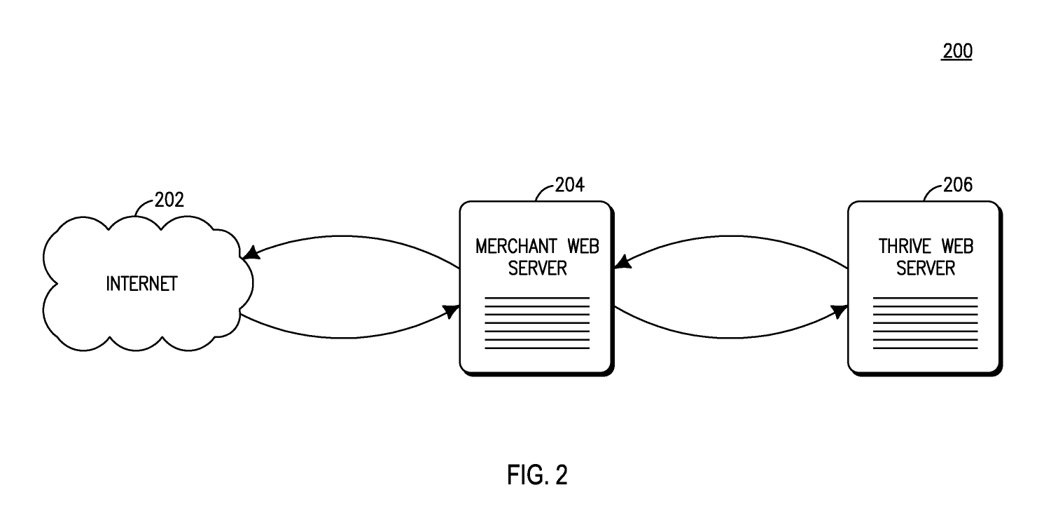

FIG. 2 illustrates a reverse proxy method 200 wherein external static web pages may be displayed over the Internet 202, using a reverse proxy setup from the merchant web server 204, which serves as a commerce host. The commerce host may be a host which, among other things, accepts transactions from consumers. The merchant web server 204 acts as a reverse proxy when requests are made for savings center pages similar to a load balancer in that the merchant's traffic is invisibly forwarded to the Thrive web server 206, page rendering is performed and the rendered pages are returned to the requesting user as if they came from the merchant web server 204.

A merchant may integrate to the savings center platform via a back-end SDK. A merchant may integrate into the site using a back end Software Development Kit (SDK), and then by employing a type of page caching method, the pages are served efficiently. Multiple programming languages and plugins for e-commerce systems could be offered as an SDK. Final output may be fully rendered savings center pages on a customer's website.

Alternatively, a merchant may create a subdomain which resolves to one or more servers whereby content is served offsite. For instance: http://savingscenter.merchantsite.com.

A merchant may create a landing page on their own domain which is then linked to pages on a controlled domain that contains details on all of the offers. A provider may host the pages after the landing page. The landing page is hosted on the customer site, and then linked tree of pages are hosted on the providers domain.

A merchant integrates into their site using a front-end Javascript Application Programming Interface (API). All pages may be created by the merchant using the provider API. This is dependent on the Javascript being indexable.

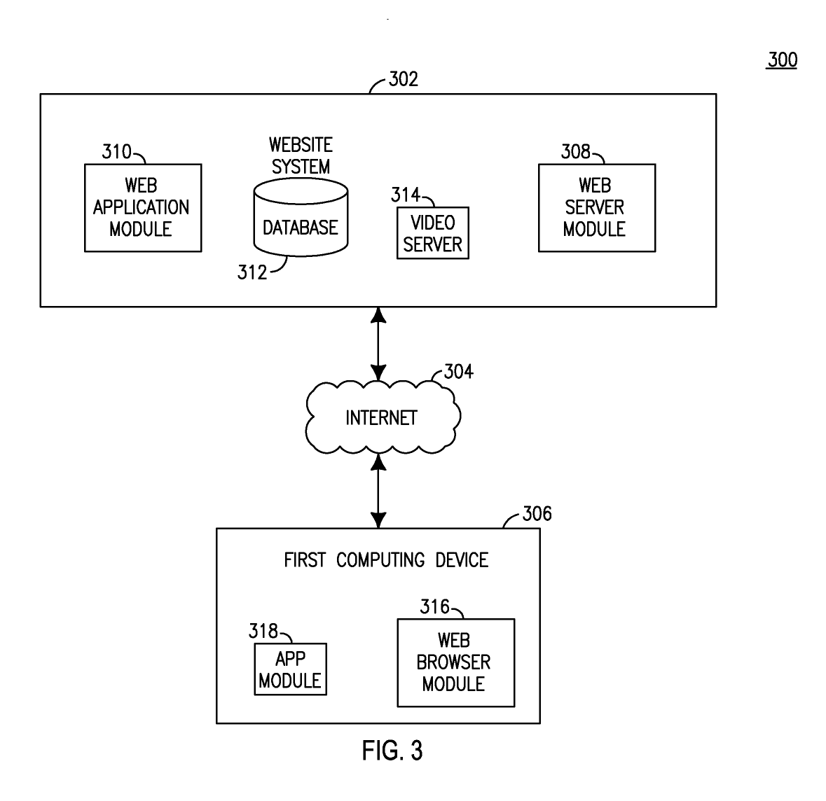

The database design for the savings center platform may be logically broken down as described herein. An exemplary database 312, which may comprise some or all of the database design techniques disclosed herein, is shown in FIG. 3.

A multi-tenant design is described whereby the database may store data for multiple clients using the savings center. Data for each client may be stored separately and not be co-mingled. At their option, clients may have a private setup in which they have a private savings center platform purely for their own use.

Configuration data may be provided for each client. There may be a significant number of configuration parameters that will feed into the rules that generate the web pages for such client. Examples of such configuration parameters include: client name; client e-commerce domain; analytics tracking IDs, for example, Google analytics property ID); social app credentials, for example, Facebook App ID; SEO optimized headings for index page; SEO optimized title tags; SEO optimized meta descriptions; SEO optimized pitch descriptions; and/or an arbitrary number of SEO copy for targeting specific search terms. SEO copy is human-readable text that is carefully selected and crafted so that Google and other search engine indexing schemes will more likely favor the selected text over any other given text that, to humans, is effectively identical semantically. For example, using certain keywords instead of synonyms for the keywords.

For each client there may be analytics data generated by shoppers who use the savings center. This data may be stored in the database and may include information such as how the shopper arrived to the savings center, for example, through a referral source, objects/elements on the Savings Center webpages clicked on by the shopper, offers/coupons clicked/clipped by the shopper, purchases made by shoppers who visited the savings center and the offers they applied (if any), any social sharing of the offers in the Savings Center by the shoppers, and technical details such as the shopper's browser, Internet Protocol (IP) address, operating system (OS), screen resolution. Also included may be previous searches conducted by the shopper to look for specific offers and filters applied by the shopper to focus on offers that meet specific criteria.

Administrative data may be stored in a section of the database to hold administrative information for each client including authorized users, roles and permissions for each user, and an audit trail of changes made by each user.

Offers data may also be stored in a section of the database which will hold all of the offers from the merchant. Each offer may be comprised of many fields that fully describe the offer including offer name, offer description, terms and conditions, offer value, offer type, start date, expiration date and a variety of other fields.

A content generator may operate as described herein. The content generator may produce a set of interlinked webpages that may be published into the merchant's website. The content generator may pull a given client's information from the database. This data may include all SEO optimized content defined in the client configuration.

The content generator may then use this data with a series of templates to create the skeleton of a savings center page. This skeleton may include the client-specific header and footer for branding, SEO optimized heading, subheading, pitch text, and SEO optimized title and meta tags, as well as other client data. The content generator may then pull the information for all of a client's offers from the database. This data is then run through another set of templates, which creates the offer cards representing each offer on the Savings Center page. An offer card contains all of the offer specific information and functions for using and sharing the offer on the savings center page. These cards may then be combined with the pages created using the client data. Generated pages may then be bundled with stock resources used for each installation. These stock resources manage dynamic page interactions, page styles, and communication with the back-end systems. The bundled savings center can then be downloaded or automatically deployed to the client e-commerce platform, extracted, and deployed for production use.

FIG. 3 shows an example architecture 300 including a web site system 302, a computing device 306, and the Internet 304. The web site system 302 of FIG. 3 includes hardware (such as one or more server computers) and software for providing and/or hosting a savings center platform as described. The computing device 306 described above may be used to download and run a local application to act as an interface to a merchant shopping point. Alternatively, an end user may use the computing device to display and interact with the web pages that make up the interactive web site. The computing device 306 may be, for example, a laptop or desktop computer, a tablet computer, a smartphone, a Personal Digital Assistant (PDA), and/or any other appropriate type of device.

The web site system 302 includes a web server module 308, a web application module 310, and a database 312, which, in combination, store and process data for providing the web site. The web application module may provide the logic behind the web site provided by the web site system 302, and/or perform functionality related to the generation of the web pages provided by the web site system 302. The web application may communicate with the web server module for generating and serving the web pages that make up the web site. A video server 314 may also be included in an exemplary web site system 302.

The computing device 306 may include a web browser module, which may receive, display, and interact with the web pages provided by the web site system 302. The web browser module 316 in the computing device 306 may be, for example, a web browser program such as Internet Explorer, Firefox, Opera, Safari, and/or any other appropriate web browser program. To provide the web site to the user of the computing device, the web browser module in the computing device and the web server module may exchange HyperText Transfer Protocol (HTTP) messages, per current approaches that would be familiar to a person of ordinary skill in the art. The computing device 306 may also include an application (app) module 318 wherein one or more applications may run and provide an interface between a user or shopper and the web site system 302.

As described hereinabove, details regarding the interactive web site and the pages of the web site (as generated by the web site system and displayed/interacted with by the user of the computing device) are provided.

The web site may include any number of different web pages, including but not limited to the following: a front (or “landing”) page; a search results page; an account landing page; and a screening window page.

Via the account landing page, the user is able to perform actions such as: set options for the user's account; update the user's profile; customize the landing page and/or the account landing page; post information; perform instant messaging/chat with other users who are logged in; view information related to bookmarks the user has added; view information regarding the user's friends/connections; view information related to the user's activities; and/or view available deals.

Advertising may be integrated in any number of different ways. As one example, each or any of the pages in the web site may include banner advertisements, videos, or other formats. Alternatively, video advertisements may be played, and/or be inserted periodically.

The components in the web site system (web server module, web application module, outgoing video module) may be implemented across one or more computing devices (such as, for example, server computers), in any combination.

The database of the web site system may be or may include one or more relational databases, one or more hierarchical databases, one or more object-oriented databases, one or more flat files, one or more structured files, and/or one or more other files for storing data in an organized/accessible fashion. The database may be spread across any number of computer-readable storage media. The database may be managed by one or more database management systems in the web site system, which may be based on technologies such as Microsoft Structured Query Language (SQL) Server, MySQL, PostgreSQL, Oracle Relational Database Management System (RDBMS), a NoSQL database technology, and/or any other appropriate technologies and/or combinations of appropriate technologies. The database in the web site system may store information related to the web site provided by the web site system, including but not limited to any or all information described herein as necessary to provide the features offered by the web site.

The web server module implements the Hypertext Transfer Protocol (HTTP). The web server module may be, for example, an Apache web server, Internet Information Services (IIS) web server, nginx web server, and/or any other appropriate web server program. The web server module may communicate HyperText Markup Language (HTML) pages, handle HTTP requests, handle Simple Object Access Protocol (SOAP) requests (including SOAP requests over HTTP), and/or perform other related functionality.

The web application module may be implemented using technologies such as PHP: Hypertext Preprocessor (PHP), Active Server Pages (ASP), Java Server Pages (JSP), Zend, Python, Zope, Ruby on Rails, Asynchronous JavaScript and XML (Ajax), and/or any other appropriate technology for implementing server-side web application functionality. In various implementations, the web application module may be executed in an application server (not depicted in FIG. 3) in the web site system that interfaces with the web server module, and/or may be executed as one or more modules within the web server module or as extensions to the web server module. The web pages generated by the web application module (in conjunction with the web server module) may be defined using technologies such as HTML (including HTML5), eXtensible HyperText Markup Language (XHMTL), Cascading Style Sheets, Javascript, and/or any other appropriate technology.

Alternatively or additionally, the web site system may include one or more other modules (not depicted) for handling other aspects of the web site provided by the web site system.

The web browser module in the computing device may include and/or communicate with one or more sub-modules that perform functionality such as rendering HTML, rendering raster and/or vector graphics, executing JavaScript, decoding and rendering video data, and/or other functionality. Alternatively or additionally, the web browser module may implement Rich Internet Application (RIA) and/or multimedia technologies such as Adobe Flash, Microsoft Silverlight, and/or other technologies, for displaying video. The web browser module may implement RIA and/or multimedia technologies using one or web browser plug-in modules (such as, for example, an Adobe Flash or Microsoft Silverlight plugin), and/or using one or more sub-modules within the web browser module itself. The web browser module may display data on one or more display devices (not depicted) that are included in or connected to the computing device, such as a liquid crystal display (LCD) display or monitor. The computing device may receive input from the user of the computing device from input devices (not depicted) that are included in or connected to the computing device, such as a keyboard, a mouse, or a touch screen, and provide data that indicates the input to the web browser module.

Although the example architecture of FIG. 3 shows a single computing device, this is done for convenience in description, and it should be understood that the architecture of FIG. 3 may include, mutatis mutantis, any number of computing devices with the same or similar characteristics as the described computing device.

Although the methods and features are described herein with reference to the example architecture of FIG. 3, the methods and features described herein may be performed, mutatis mutantis, using any appropriate architecture and/or computing environment. Alternatively or additionally, although examples are provided herein in terms of web pages generated by the web site system, it should be understood that the features described herein may also be implemented using specific-purpose client/server applications. For example, each or any of the features described herein with respect to the web pages in the interactive web site may be provided in one or more specific-purpose applications. For example, the features described herein may be implemented in mobile applications for Apple iOS, Android, or Windows Mobile platforms, and/or in client application for Windows, Linux, or other platforms, and/or any other appropriate computing platform.

For convenience in description, the modules (web server module, web application module, and web browser module) shown in FIG. 3 are described herein as performing various actions. However, it should be understood that the actions described herein as performed by these modules are in actuality performed by hardware/circuitry (i.e., processors, network interfaces, memory devices, data storage devices, input devices, and/or display devices) in the electronic devices where the modules are stored/executed.

What is claimed is:

1. A method for distributing information over the Internet, the method comprising:
retrieving, by a content generator, information relating to a given client, wherein the information includes search engine optimized (SEO) content stored in a configuration database;
combining, by the content generator, the retrieved information with one or more page templates;
creating, by the content generator, a savings center page with the combined retrieved information and the one or more page templates; and
publishing the savings center page.

2. The method of claim 1, further comprising providing a report indicating activity logs of users who have visited the web pages.

3. The method of claim 1, further comprising receiving data entry parameters comprising deal data.

4. The method of claim 1, further comprising receiving control data.

5. The method of claim 1, wherein publishing the savings center page includes publishing the savings center page to a website corresponding to a merchant.

6. A server comprising:
a content generator subsystem comprising instructions for generating content for display on merchant shopping points;
a control panel for system administration;
a data entry subsystem configured to accept promotions and offer data either manually or via a feed; and
a reporting subsystem for generating at least one report about performance of the promotions and offer data.

7. The server of claim 6, wherein the reporting subsystem is configured to generate an activity log of users who have visited the web pages.

8. The server of claim 6, further comprising:
a multi-tenant database configured to store data for a plurality of clients.

9. The server of claim 8, wherein the database is configured to store a client name, a client e-commerce domain name, one or more analytics tracking IDs, and at least one social application credential.

10. The server of claim 9, wherein the database is further configured to store search engine optimized (SEO) headings for an index page.

11. The server of claim 6, wherein the content generator subsystem is in communication with an Apache web server.

12. A commerce savings center platform, comprising:
a content generator configured to retrieve information relating to a given client, wherein the information includes search engine optimized (SEO) content stored in a configuration database and wherein the content generator is further configured to combine the retrieved information with one or more page templates to create a savings center page; and
a web server configured to publish the savings center page.

13. The commerce savings center platform of claim 12, wherein the web server is an Apache web server.

14. The commerce savings center platform of claim 12, further comprising a multi-tenant database configured to store data for a plurality of clients.

15. The commerce savings center platform of claim 12, further comprising a reporting system configured to generate an activity log of users who have visited the savings center page.

16. The commerce savings center platform of claim 12, further comprising a data entry subsystem configured to accept promotions and offer data either manually or via a feed.
